(19) United States
(12) Patent Application Publication
(10) Pub. No.: US 2017/0212016 A1
(43) Pub. Date: Jul. 27, 2017

(54) Method for Depositing Amounts of Liquid

(71) Applicant: Edward Lee Galloway, Lumberton, TX (US)

(72) Inventor: Edward Lee Galloway, Lumberton, TX (US)

(73) Assignee: Helena Laboratories Corporation, Beaumont, TX (US)

(21) Appl. No.: 15/005,394

(22) Filed: Jan. 25, 2016

(51) Int. Cl. G01N 1/28

(52) U.S. Cl. CPC G01N 1/28

(57) ABSTRACT

A method for filling a receptacle with a precise amount of liquid includes filling the receptacle while forming a controlled meniscus to prevent spillage. If an excess amount of liquid is deposited, then excess is then withdrawn such that the receptacle contains only the desired amount of liquid.

### BACKGROUND

A method for providing an accurate amount of fluid in a receptacle such that an accurate amount of fluid may thereafter be transferred from the receptacle. This method has a particular utility in the medical field such as for placing precise amounts of samples and/or chemicals on a substrate but is not limited to that use.

Scientists and medical technicians are constantly searching for better ways to place, transfer and/or apply samples and reagents on various substrates for testing or diagnostic-type purposes. The placement, volume, and dimensions of such samples and reagents on a substrate are important to the reliability and accuracy of the procedures thereafter carried out on the samples. In some instances, improper application of the samples on a substrate will significantly alter the test results, making them unreliable, and may even precluded obtaining any test results at all.

Another problem is that reproducibility of the procedure and results and thus reliability of test results is important but such reproducibility is adversely impacted when differing amounts of samples and/or reagents are transferred when it is the intent to transfer the same amount of sample and/or reagent.

The present method has a particular but non-limiting use in connection with immuno-fixation electrophoresis. Background information on immuno-fixation electrophoresis, also referred to as IFE, 15 available, for example from the following: (a) U.S. Pat. No. 4,668,363 to Gebott et al, issued on May 26, 1987; (b) U.S. Pat. No. 5,137,614 to Golias, issued on Aug. 11, 1992; (c) U.S. Pat. No. 5,185,066 to Golias, issued on Feb. 9, 1993; (d) U.S. Pat. No. 5,405,516 to Bellon, issued on Apr. 11, 1994, (e) U.S. Pat. No. 6,165,541 to Merchant et al, issued on Dec. 26, 2000; and (f) U.S. Pat. No. 6,544,395 to Merchant et al, issued on Apr. 8, 2003. The entirety of each of the foregoing is hereby incorporated by reference.

With particular reference, for example, to U.S. Pat. No. 5,137,614 it may be understood that samples (or reagents, or controls) are to be transferred such as from depressions or receptacles or wells 16-20 in a onto a substrate such as, for example, through the use of an applicator of the type illustrated in U.S. Pat. No. 6,544,395. If, however, the amount of liquid in the receptacle or well is not consistent, from test-to-test, the tips of the applicator will withdraw and then transfer to the electrophorese gel plate or the like, an inconsistent or different amount of liquid as between tests.

Typically, when liquid is placed in a receptacle a meniscus is created. Surface tension and adhesion of the liquid to the receptacle are factors in determining whether the \meniscus is convex or concave. These factors also contribute to the degree or extent of the meniscus relative to the plane of the top of the receptacle. Surface tension is related, of course, to the nature of the liquid. In the environment of IFE, the receptacles are typically formed in a plate made of polystyrene and the liquid reagents are frequently antigens.

### SUMMARY

The inventor has determined that the meniscus itself is a fundamental cause of the problem of inconsistent amounts of fluid being transferred by the applicator. Thus the inventor has developed a novel methodology for controlling the filling of receptacles to essentially eliminate the meniscus or at least minimize or otherwise control the meniscus such that consistent amounts of liquid may be withdrawn from the receptacles.

### BRIEF DESCRIPTION OF THE DRAWINGS

The various benefits and advantages of the present invention will become apparent upon reading the following detailed description taken in conjunction with the drawings.

In the drawings, wherein like reference numerals identify corresponding parts:

FIG. 1 is a perspective illustration of a plate having multiple rows of receptacles;

FIG. 2 comprises each of FIG. 2A, FIG. 2B, FIG. 2C and FIG. 2D;

FIG. 2A and FIG. 2B are cross-sectional illustrations of the plate of FIG. 1 with a diagrammatic illustration of withdrawing liquid from one of the receptacles; and

FIG. 2C and FIG. 2D are diagrammatic illustrations of placing liquid in one of the receptacles.

### DETAILED DESCRIPTION

Typically, a specimen from a single patient is diluted and then placed in multiple sample or application areas on a single electrophoretic gel plate. The purpose of utilizing multiple sample areas is to enable detection, separately, of various components of the specimen.

One conventional type of IFE testing is to determine total serum protein as well as various proteins such as the immunoglobin heavy chains IgG, IgM, IgA and light chains Kappa and Lambda, or other proteins whose presence or absence may be of importance in medical diagnosis and treatment. It is common in IFE testing to deposit antigens or antisera to the foregoing proteins onto the sample from the patient. Both qualitative (presence or absence) and quantitative (amount) of the proteins is of importance. As an alternative to depositing the antigens or antibodies onto the samples, the antibodies or antigens may be placed on an electrophoresis plate before the sample is deposited on the plate. In either situation, the antibodies/antigens are positioned to react with the protein in the sample.

It may thus be immediately appreciated that successive tests on the same patient undergoing treatment, for example at 24 hour intervals, may provide inaccurate results if different quantities of the antigens are utilized. Thus consistency in the amount of antigens deposited on the sample is of significance.

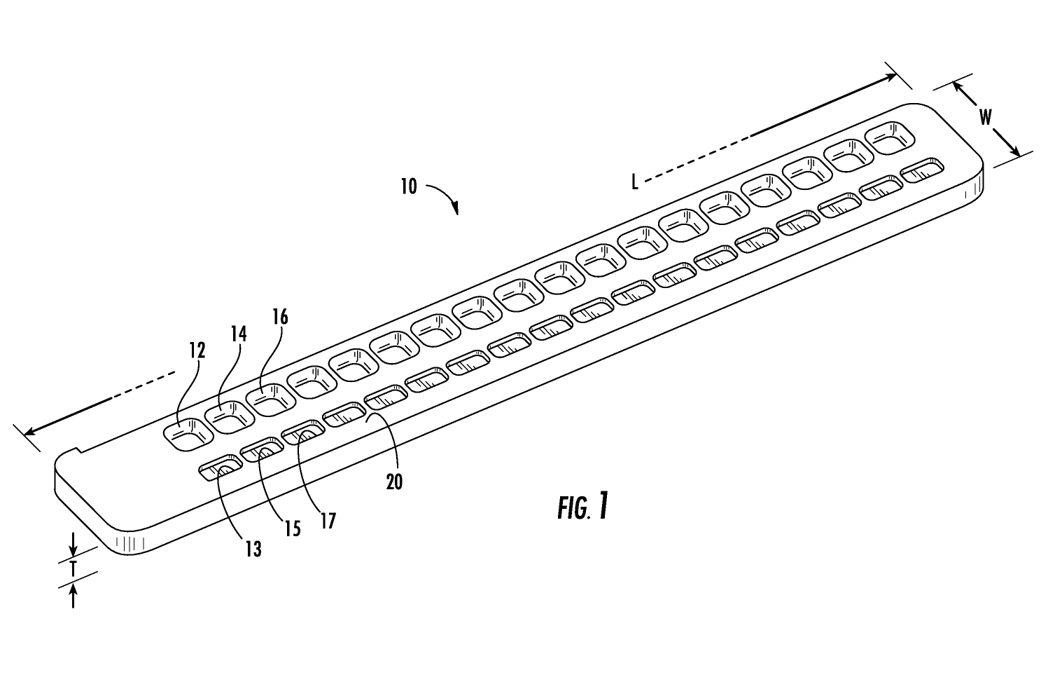

Referring first to FIG. 1 a plate 10 is illustrated as having a length “L”, a width “W” and a thickness “T”. The length is greater than the width and thus plate 10 will be referred to as an elongated plate. Preferably the plate is formed of polystyrene. However, it should be appreciated that material, shape, size and relative dimensions are presented solely for explanatory purposes and should be interpreted in a non-limiting matter.

The plate 10 includes a first series of receptacles 12, 14, 16 and a second series of receptacles 13, 15, 17. For convenience each receptacle in the first series of receptacles (or wells, or depressions) will be identified with an even numeral and each receptacle in the second series of receptacles will be identified with an odd numeral. The receptacles extend downwardly into the plate from a top surface 20. Each receptacle in the first series is preferably aligned with a corresponding receptacle in the second series. Each receptacle in the first series is configured to retain a greater quantity of liquid that the corresponding receptacle in the second series. Thus the first series of receptacles may be thought of as reservoirs. Each receptacle in the second series is configured to retain the quantity of fluid needed for a single test and thus the second series of receptacles may be thought of as “sample” receptacles.

As explained above and in the patents incorporated by reference, it is known in IFE to test for total serum protein as well as IgG, IgM, IgA and light chains Kappa and Lambda. Thus a total of six sets or pairs of receptacles would be allocated to each patient. If the plate 10 includes 30 receptacles in each series, then IFE may be performed on five samples (e.g., from five patients) concurrently.

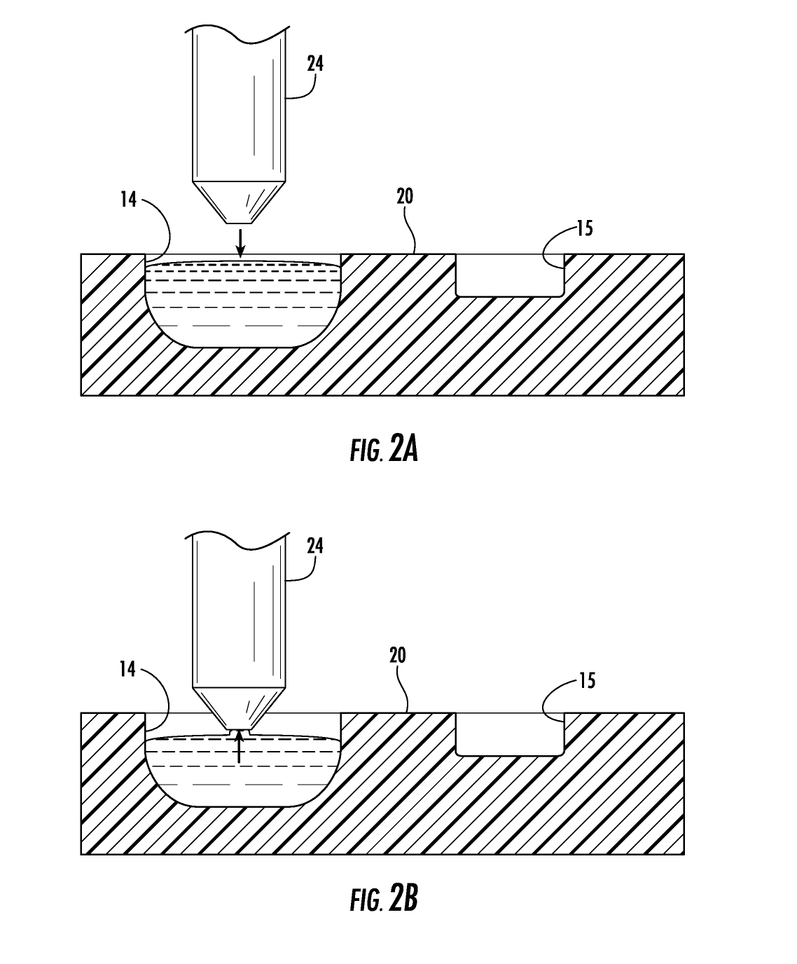

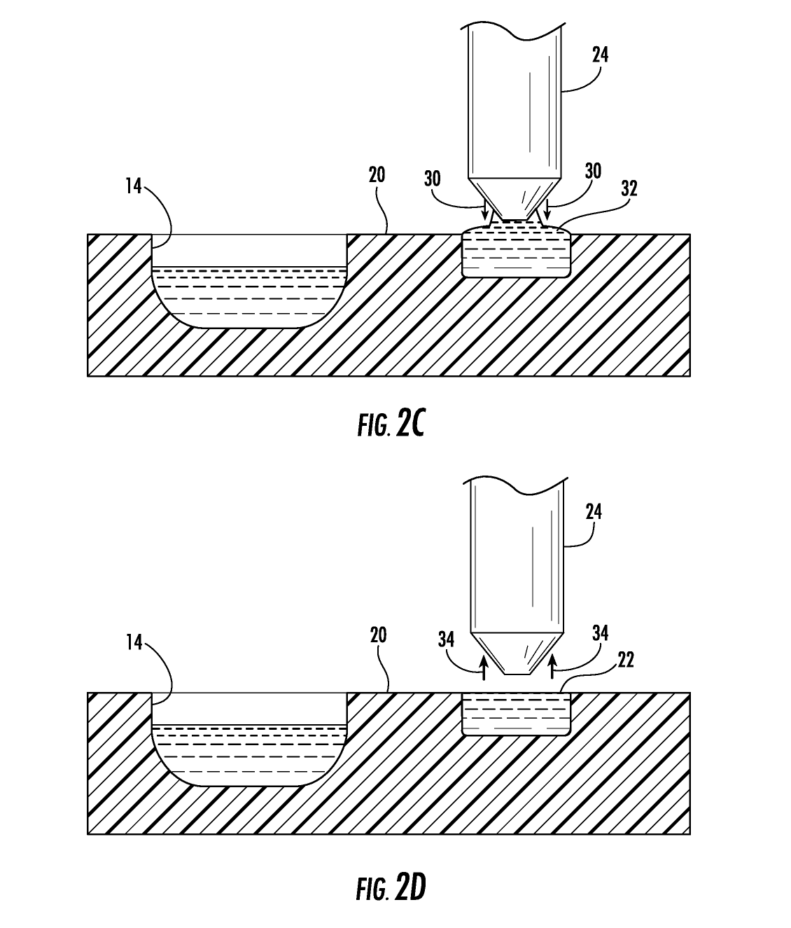

Referring next to FIG. 2A a large receptacle 14 is illustrated as having been filled with a liquid 22. The quantity of liquid preferably exceeds the quantity necessary for a single IFE test. If the plate 10 includes 30 sets of receptacles in each series, as described above, preferably all 30 receptacles in the first series may be filled concurrently.

A next step would be to transfer an appropriate amount of the liquid 22 from receptacle 14 (a reservoir receptacle) to the corresponding smaller “sample” receptacle 15. FIG. 2A and FIG. 2B illustrate, diagrammatically, the use of an instrument such as a needle or pipette (manual or automated) 24 for this purpose. In FIG. 2A the instrument 24 is illustrate with an arrow 26 as moving downwardly into the liquid 22 and in FIG. 2B liquid 22 is illustrated as being withdrawn upwardly in the direction of arrow 28 into the instrument 24. Again, if the plate 10 includes 30 sets of receptacles in each series, as described above, preferably liquid is withdrawn from each receptacle in the first series concurrently. For this purpose, there will be an instrument 24 for each aligned set or pair of receptacles.

Referring next to FIG. 2C the instrument 24 moves downwardly in the direction of arrows 30 and deposits liquid 22 into a corresponding receptacle 15. The liquid is illustrated as “overflowing” the receptacle 15, that is, the quantity of liquid is in excess of the capacity of the receptacle 15 and a convex meniscus 32 is formed. The needle or instrument 24 acts as an anchor to which excess fluid adheres. Contact between the fluid 22 and the exterior of the instrument results in surface tension between the needle and the fluid thus tending to preclude the liquid 22 from overflowing the receptacle 15 or spilling on the plate 20 over the edges of the receptacle.

In FIG. 2D the instrument 24 is withdrawn from intimate contact with the liquid 22 as illustrated with arrows 34. Excess liquid is withdrawn through the instrument 24 so that only the desired amount of liquid is retained in the receptacle 15. Thus the top of the liquid 22 in receptacle 15 is now coplanar with the top of the plate 20. Any remaining meniscus (concave or convex), even if deliberately formed, is sufficiently miniscule such that the IFE results and reproducible and reliable at least with respect to the amount of antigens/antisera being used.

Alternatively, if desired, the amount of liquid 22 withdrawn by the instrument 24 from the sample receptacle 15 may be such so as to result in a deliberate meniscus, concave or convex, as long as the quantity is controlled as desired and spillage or undesirable overflow is avoided.

In the case of IFE as historically performed using equipment manufactured and marketed by Helena Laboratories, Inc., of Beaumont, Tex., assignee of the present application, receptacle 15 is of a size and shape such that it will hold exactly 17 microliters. (17 μl) It should be understood, therefore, that the shape of the receptacle 15 need not be rectangular. Once again, it is preferable to perform the steps illustrated in FIG. 2C and FIG. 2D concurrently for each of the 30 sets of receptacles in the plate 10.

Conventionally, an applicator will be used to transfer liquid from the sample receptacles 13, 15, 17 onto the electrophoresis plate. In a non-limiting example, the applicator will have 6 tips if liquid is being transferred for IFE evaluation of total serum protein plus IgG, IgM, IgA and light chains Kappa and Lambda. The applicator may have 30 tips if the same evaluation is to be made on five patients concurrently. One suitable applicator is illustrated and described in the aforementioned U.S. Pat. No. 6,544,395. The liquid 22 may adhere to the tip of the applicator by surface tension.

In a typical clinical laboratory or hospital setting, after the IFE procedure has been completed on a first group of patients, the samples from a second group of patients is to be subjected to IFE evaluation. For this purpose, liquid from the larger receptacles 12, 14, 16 may be transferred to the corresponding smaller receptacles 13, 15, 17 by repeating the procedure described above.

One of the benefits of the present method is that a precise amount of liquid may be placed in the sample receptacle 15 to thereafter be transferred onto the electrophoresis plate. By avoiding overflow of the receptacle 15, there is less waste of liquid. Even if it is desired to have a deliberate, albeit small, concave or convex meniscus in receptacle 15, the present method provides for more control over the amount of liquid in the receptacle 15 and therefore reduces waste. The control over the amount of liquid reduces the need to clean the surface 20 of the plate. Thus upon removal of the instrument 24, the remaining fluid may have a concave or convex meniscus but spillage has been avoided and precision as to the amount of liquid in the receptacle has been achieved.

If the sample receptacle is intended to hold 15 μl, and if the larger reservoir is configured to hold 150 μl, then a series of ten tests may be performed without the need to refill the reservoir thus contributing to overall efficiency based on the precise control of the amount of liquid withdrawn from the reservoir as well as the precise amount of liquid introduced into the sample receptacle.

The foregoing is a complete description of a preferred embodiment of the present method. Various changes may be made without departing from the scope of the following claims therefore the invention should be limited only by the following claims and the equivalent of the following claims.

What is claimed is:

1. A method for filling a receptacle with a precise amount of liquid, the receptacle having a first capacity for liquid, comprising the steps of:
filling the receptacle with liquid while forming a controlled meniscus; and
withdrawing excess liquid from the receptacle such that the receptacle is filled with said precise amount of liquid.

2. The method according to claim 1 wherein the liquid in the receptacle includes a convex meniscus prior to said step of withdrawing liquid from the receptacle.

3. The method according to claim 1 wherein the liquid in the receptacle includes a convex meniscus after said step of withdrawing liquid from the receptacle.

4. The method according to claim 1 wherein the liquid in the receptacle includes a concave meniscus after said step of withdrawing liquid from the receptacle.

5. The method according to claim 1 wherein the liquid in the receptacle is retained by surface tension prior to said step of withdrawing liquid from the receptacle.

6. The method according to claim 1 wherein a device is provided for filling the receptacle with liquid and wherein liquid adheres to said device by surface tension.

7. The method according to claim 1 wherein the liquid in the receptacle is retained by surface tension prior to said step of withdrawing liquid from the receptacle.

8. The method. according to claim 1 wherein a plurality of receptacles are filled with liquid in excess of said first capacity concurrently

9. The method according to claim 1 wherein excess liquid is withdrawn from a plurality of receptacles concurrently.

10. The method according to claim 1 wherein the step of filling a receptacle with excess liquid includes transferring fluid from a reservoir positioned in proximity to the receptacle.

11. A method for filling a receptacle with a precise amount of liquid comprising the steps of:
withdrawing fluid from a reservoir;
initially depositing said withdrawn fluid in an amount greater than said precise amount and forming a meniscus with said fluid in the receptacle; and
withdrawing excess liquid such that the receptacle is filled only with said precise amount of liquid.

12. The method according to claim 9 wherein said meniscus is convex.

13. The method according to claim 9 wherein after said step of withdrawing excess liquid said precise amount of liquid includes a concave meniscus.

14. The method according to claim 9 wherein after said step of withdrawing excess liquid said precise amount of liquid includes a convex meniscus.
